(19) United States
(12) Patent Application Publication
(10) Pub. No.: US 2010/0319162 A1
(43) Pub. Date: Dec. 23, 2010

(54) Hinge device and apparatus using the same

(76) Inventors: Naoki Kubota, Tokyo (JP); Yoshitaka Hayashi, Tokyo (JP)

Correspondence Address: Kubotera & Associates, LLC, 200 Daingerfield Rd, Suite 202, Alexandria, VA, 22314, US

(21) Appl. No.: 12/457,709

(22) Filed: Jun. 18, 2009

(51) Int. Cl. E05D 7/04

(52) U.S. Cl. 16/236

(57) ABSTRACT

A hinge device is provided with a first cam rotating together with a first member, and a second cam rotating together with a second member. The first and second cams are provided with a cam portion and a cam engaging portion engaging with each other when the first and second members rotate to a predetermined position. A continuous groove is formed in a surface of the second cam opposite to a surface in which the cam engaging portion is formed. A ball holder rotates together with the first cam, and includes holding grooves. Balls are provided between the second cam and the ball holder, and move along the continuous groove and the holding grooves. When the cam portion and the cam engaging portion change from a partially engaged state into an engaged state, ball or transmission movable bodies pass curved portions of the continuous groove and suppress rotation.

### BACKGROUND OF THE INVENTION AND RELATED ART STATEMENT

The present invention relates to a hinge device that pivotally connects a display section with an operating section in electronic apparatuses, such as a cellular phone and a personal computer, of which a first member including a display section for displaying a receiving function, information, and the like is opened and closed; and an apparatus using the hinge device. In particular, the present invention relates to a hinge device that achieves smooth and soft rotation by the adjustment of rotational speed.

In recent years, there have been many products where a display section is pivotally connected to an operating section by a hinge device so as to be opened and closed in electronic apparatuses, such as a cellular phone and a personal computer, in order to achieve miniaturization and portability while the size of a display section is increased. When this kind of electronic apparatus is used, the display section is generally rotated to about 90° or 180°. For this reason, a hinge device in the related art is provided with a cam portion and a cam engaging portion that are rotated together with the rotation of the display section and the operating section on the assumption of this use situation, and the display section is formed to keep the cam portion and the cam engaging portion that are engaged with each other by biasing the cam portion and the cam engaging portion by a spring at a closed state and an open state (refer to Patent Reference 1).

Further, a structure, which prevents an impact during the opening and closing of the display section by adjusting the opening speed and closing speed of the display section and smoothly operating the display section, is used even in this kind of electronic apparatus. For example, there has been used a structure where a ring-shaped elastic member made of rubber is mounted on a shaft portion of a hinge and a frictional force is generated between the elastic member and shaft portion by suppressing the rotation of the elastic member (refer to Patent Reference 2). Meanwhile, a shaft and a cylindrical member, which is made of soft plastic and restricts the shaft, have been used as a structure that brakes the rotation (refer to Patent Reference 1).
Patent Reference 1: Japanese Patent Publication No. 10-306645
Patent Reference 2: Japanese Patent Publication No. 11-141536

The structure, which decelerates or brakes the rotation of the hinge device by restricting the shaft with the ring-shaped or cylindrical elastic member made of rubber or soft plastic as described in the related art, has had problems in that the elastic member is abraded, deteriorated, or hardened as a long time passes, thereby deteriorating braking ability.

Further, in the above-mentioned related art, a plurality of cylindrical elastic members needs to be provided or the elastic member needs to be formed to have a long length in an axial direction in order to obtain sufficient braking ability. For this reason, when the elastic member is assembled with the hinge device, the length of the hinge device is increased in the axial direction. As a result, there has also been a problem in that the miniaturization of an apparatus is obstructed.

Accordingly, the invention has been made to solve the above-mentioned problems, and an object of the invention is to provide a hinge device that has a simple structure, is easily miniaturized, is easily assembled, has excellent durability, and smoothly and softly operates, and an apparatus using the hinge device.

### SUMMARY OF THE INVENTION

A hinge device according to the present invention, which is described by using reference numerals that will be used in the later described embodiment, is a hinge device 2 that connects a first member 6 with a second member 8 so as to allow the first and second members to be rotated, The hinge device includes a first cam 10, a second cam 12, transmission movable bodies 16, a movable body holder 18, and an elastic member 20. The first cam is rotated together with the rotation of the first member and includes a cam portion 10b that is formed of one of a recessed portion and a projecting portion. The second cam is rotated together with the rotation of the second member, is engaged with the cam portion of the first cam, includes a cam engaging portion 12b that is formed of the other of the recessed portion and the projecting portion, and includes a continuous groove 12c. The continuous groove includes a plurality of curved portions 12d and 12e and is formed in a rotation direction on a surface opposite to a surface of the second cam on which the cam engaging portion is formed. The transmission movable bodies are moved in the continuous groove. The movable body holder is rotated together with the rotation of the first cam, and positions the transmission movable bodies so that the transmission movable bodies pass the curved portions of the continuous groove when the state of the cam portion and the cam engaging portion is changed from a partially engaged state into an engaged state. The movable body holder includes holding grooves 18c that allow the transmission movable bodies to be moved and are formed in a radial direction on a surface of the movable body holder facing the continuous groove. The elastic member presses the movable body holder to bias the movable body holder toward the second cam. When the first and second members are rotated relative to each other and the state of the cam portion and the cam engaging portion is changed from the partially engaged state into the engaged state, the transmission movable bodies pass the curved portions of the continuous groove so that the rotation of is suppressed.

In the hinge device, three or more transmission movable bodies may preferably be provided from the viewpoint of a balance, and when the engaging state of the cam portion and the cam engaging portion is changed from the partially engaged state into the engaged state, the movable body holder may position the transmission movable bodies so that at least one of the transmission movable bodies passes the curved portion of the continuous groove.

Furthermore, the continuous groove may preferably include a plurality of curved portions that have a plurality of radii of curvature.

In addition, the plurality of curved portions may preferably include curved portions having a large radius of curvature and curved portions having a small radius of curvature that are alternately disposed. Further, the holding grooves may preferably be formed at regular intervals in a circumferential direction.

Furthermore, the transmission movable bodies are so positioned that when the engaging state of the cam portion and the cam engaging portion is changed from the partially engaged state into the engaged state, the plurality of transmission movable bodies may pass the curved portions of the continuous groove.

In addition, the continuous groove preferably has the depth which may be changed, and the holding grooves may have depth corresponding to the change of the depth of the continuous groove so that the transmission movable bodies are movably held by the holding grooves. Further, the transmission movable body may be formed in the shape of a ball, as an example.

Meanwhile, in an apparatus, which uses a hinge device, according to the present invention, a first member and a second member are pivotally connected to each other by the hinge device, and the hinge device of the present invention is used as the hinge device.

In the hinge device according to the present invention, when the engaging state of the cam portion and the cam engaging portion is changed from the partially engaged state into the engaged state, that is, for example, when the first and second members are rotated to a predetermined angle and opened up to a predetermined position so that the cam portion is dropped in the cam engaging portion, the transmission movable bodies pass the curved portions of the continuous groove. Accordingly, the rotation is suppressed, so that the first and second members are smoothly and softly decelerated and stopped. As described above, the hinge device according to the present invention includes the first cam, the second cam, the transmission movable bodies, and the movable body holder that are disposed in the axial direction. The hinge device has a simple structure, wherein particularly grooves and transmission movable body are added to a cam mechanism. Therefore, it may be possible to easily miniaturize the hinge device.

Further, as described above, in the hinge device according to the present invention, it is possible to assemble the component parts sequentially in the axial direction. Therefore, it is easy to assemble the hinge device and to improve mass productivity.

Furthermore, in the present invention, braking is performed by suppressing the rotation when the transmission movable bodies pass the curved portions of the continuous groove. Accordingly, parts made of rubber or the like are not necessary, and it is possible to improve the durability of the hinge device without abrasion, deterioration, and hardening as compared to when these parts are used.

Further, in the present invention, driving torque is transmitted between the second cam and the ball holder by the movement, which is caused by the rolling or slide of the transmission movable bodies. For this reason, since the rotation is very smooth as compared to the structure where rotation is transmitted by the slide between the elastic member and the shaft body like in the related art, it is possible to obtain smooth rotation.

### BRIEF DESCRIPTION OF THE DRAWINGS

FIG. 1 is an exploded perspective view of a hinge device according to an embodiment of the invention;

FIG. 2 is a perspective view of a cellular phone that uses the hinge device shown in FIG. 1;

FIG. 3 is a perspective view of the hinge device shown in FIG. 1;

FIG. 4 is a cross-sectional view of the hinge device shown in FIG. 2;

FIG. 5 is a perspective view showing main parts of the cellular phone shown in FIG. 2;

FIG. 6 is a front view showing an end face of a second cam that faces a ball holder shown in FIG. 5; and

FIG. 7 is a front view showing an end face of the ball holder that faces the second cam shown in FIG. 5.

### DETAILED DESCRIPTION OF THE PREFERRED EMBODIMENTS

A hinge device according to the invention pivotally connects a first member with a second member. The first and second members overlap each other and are opened and closed while being used like an operating section and a display section of an apparatus. The hinge device is provided with a first cam that is rotated together with the rotation of the first member, and a second cam that is moved together with the rotation of the second member. A cam portion and a cam engaging portion, which are engaged with each other when the first and second members are rotated up to a predetermined position, are formed on the surfaces of the first and second cams that face each other, respectively. Further, a continuous groove is formed on the surface of the second cam opposite to the surface on which the cam engaging portion is formed. The continuous groove includes a plurality of curved portions, and continues in a rotation direction of the second cam. Furthermore, a movable body holder, which is rotated together with the first cam and includes holding grooves formed so as to face the continuous groove of the second cam, is provided. The holding grooves are formed in a radial direction, and three or more transmission movable bodies are movably held by the holding grooves. Three or more transmission movable bodies are disposed between the second cam and the movable body holder with a good balance so that the second cam or the ball holder is not inclined. Accordingly, the transmission movable bodies are moved by rolling or sliding along the continuous groove and the holding grooves.

The transmission movable bodies of the hinge device having the above-mentioned structure are disposed as follows: when the first and second members are rotated to a predetermined angle so as to be opened or closed, a partially engaged state where the cam portion and the cam engaging portion partially-come in contact with each other at a cam face is changed into an engaged state where the cam portion is dropped in the cam engaging portion, so that at least one transmission movable body passes the curved portion of the continuous groove. When the transmission movable bodies pass the curved portions of the continuous groove, the transmission movable bodies receive strong resistance, which is applied from a groove surface and is caused by a pressing force of the elastic member. Therefore, the rotation is suppressed. The transmission movable bodies operate so that the resistance applied from the groove surface is increased in proportion to the rotational speed of the first or second member, that is, the rotational speed of the cam portion or the cam engaging portion. When the rotational speed is high, a braking force is increased. When the rotational speed is low, a braking force is decreased. For this reason, when the first and second cams are engaged with each other, that is, when the first and second members are opened or closed to a predetermined angle, the rotational speed is decreased and the first or second member is slowly coming into a predetermined open or closed state and then stopped.

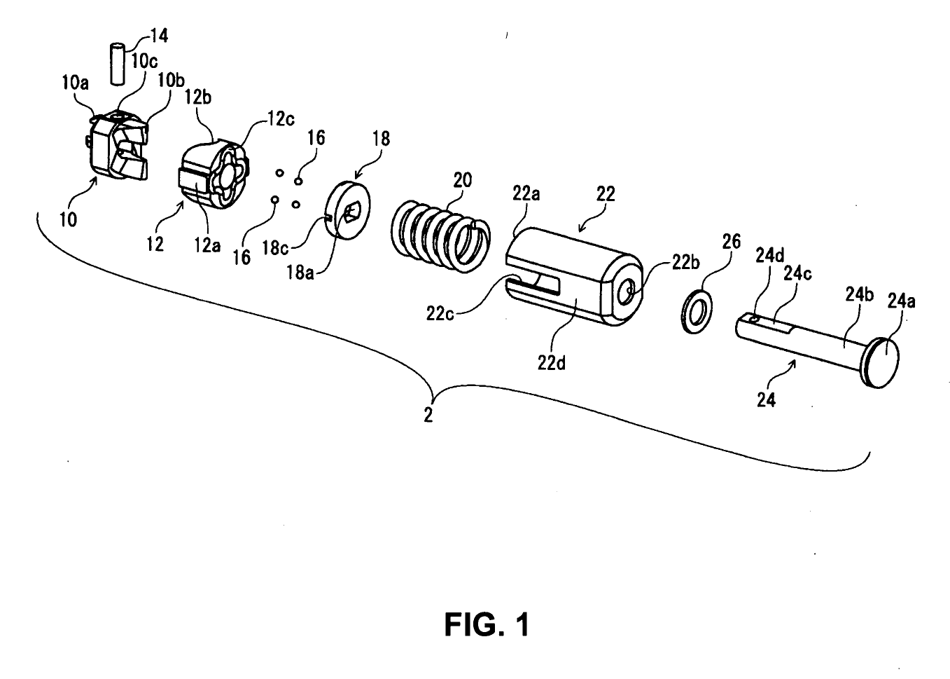

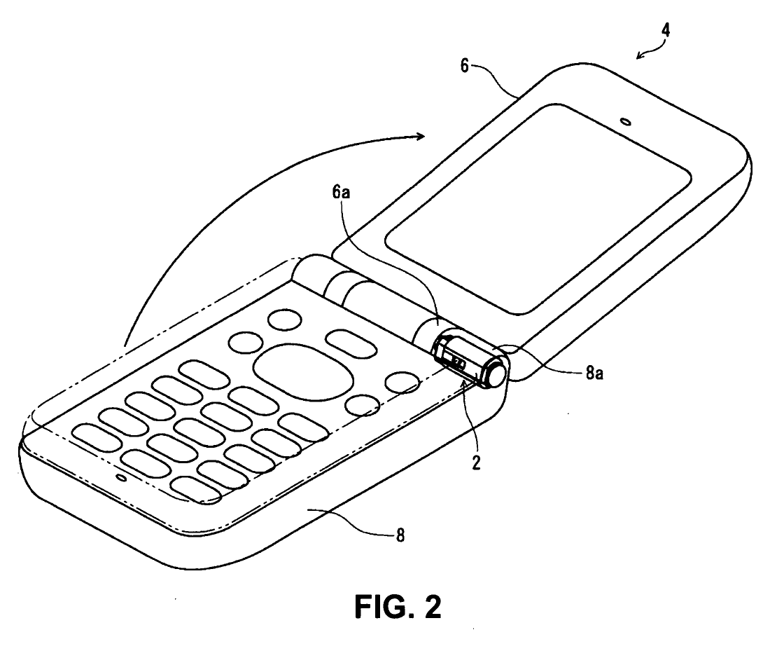

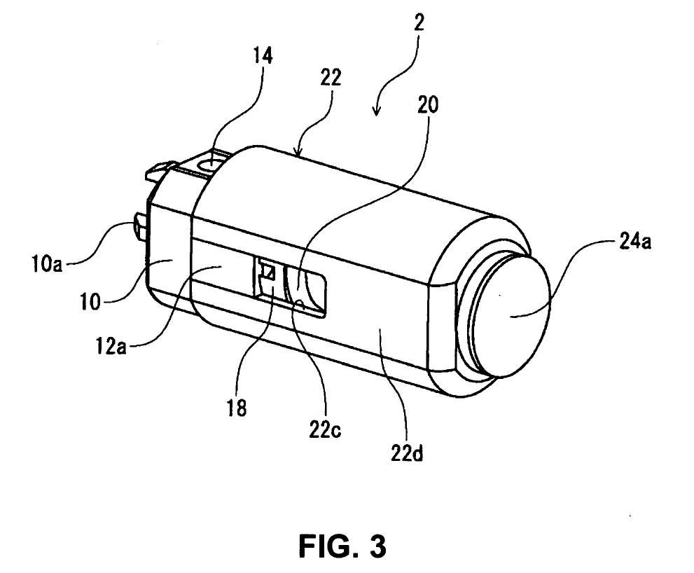

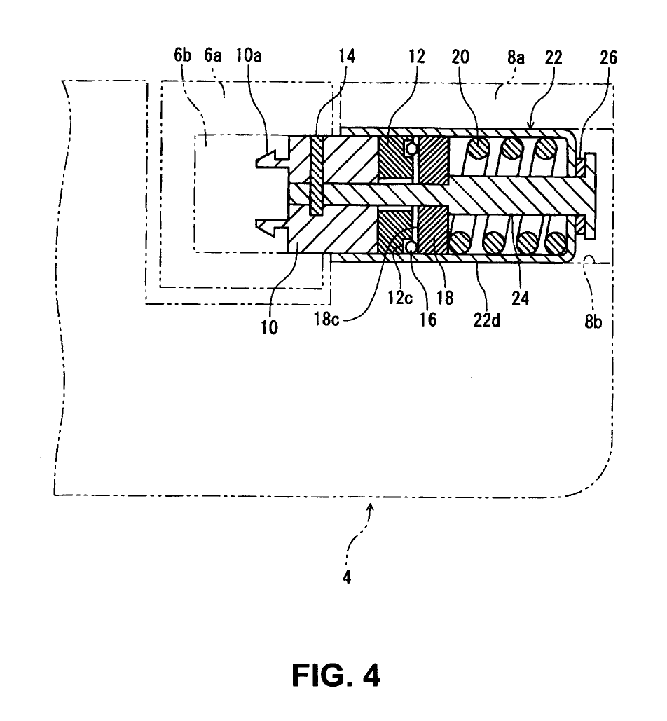

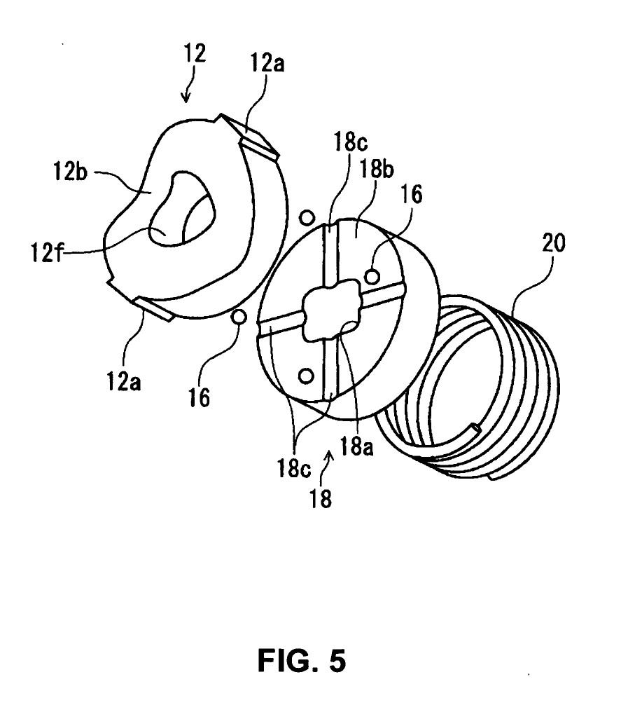

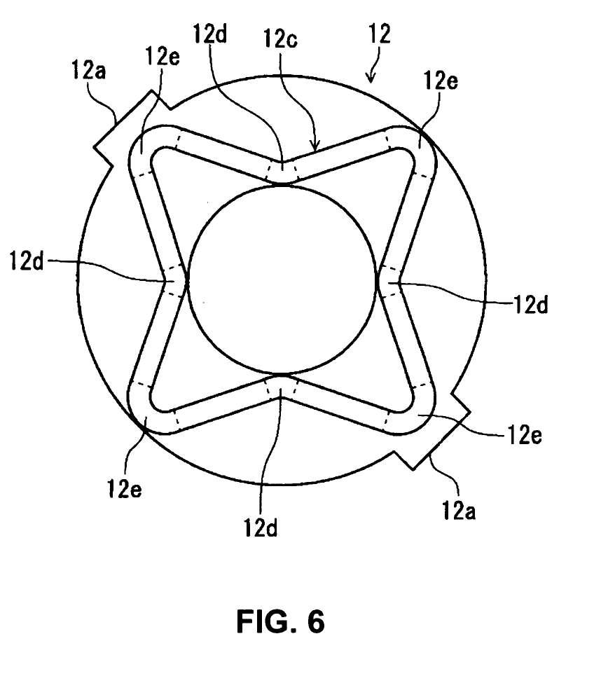

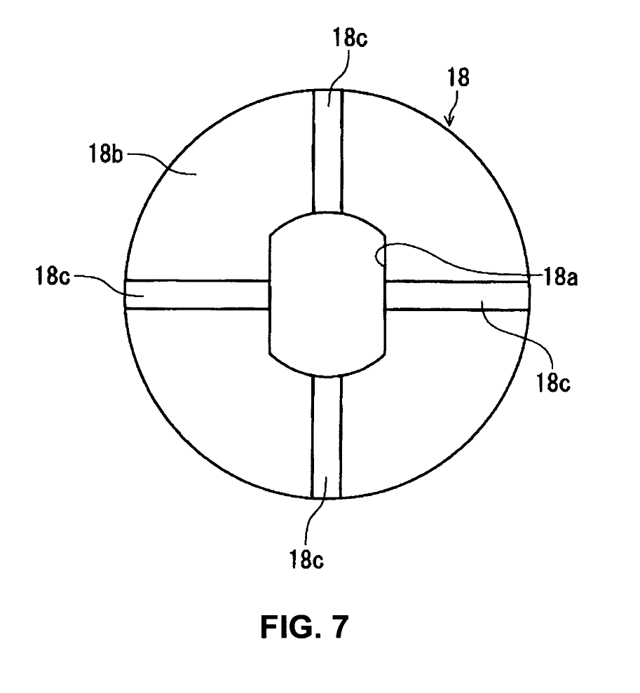

FIG. 1 is an exploded perspective view of a hinge device according to an embodiment of the invention, FIG. 2 is a perspective view of a cellular phone that uses the hinge device shown in FIG. 1, FIG. 3 is a perspective view of the hinge device shown in FIG. 1, FIG. 4 is a cross-sectional view of the hinge device shown in FIG. 2, FIG. 5 is a perspective view showing main parts of the cellular phone shown in FIG. 2, and FIGS. 6 and 7 are front views showing the surfaces, which face each other, of a second cam and a movable body holder shown in FIG. 5, respectively. Meanwhile, in this embodiment, a cellular phone will be exemplified as an apparatus that uses the hinge device according to the invention.

In the drawings, reference numeral 2 denotes a hinge device. As shown in FIG. 2, a second member 8 that has a transmitting function and includes an operating section, and a first member 6, which has a receiving function and includes a display section for displaying information or the like, of a cellular phone 4 used as an electronic apparatus are pivotally connected to each other. Tubular pivot sections 6a and 8a, which are so assembled to be engaged with each other, are provided at ends of the first and second members 6 and 8, respectively. The hinge device 2 is inserted into the pivot sections. The hinge device 2 is constituted of component parts to be described below.

As shown in FIGS. 3 and 4, reference numerals 10 and 12 denote first and second cams that are engaged with each other. The first cam 10 has a substantially cylindrical shape, and has engaging claws 10a that protrude from an outer (left in FIG. 1) end face of the first cam, and a projecting cam portion 10b that is formed on an end face of the first cam 10 facing the second cam 12. Further, an insertion hole 10c, into which an engaging pin 14 fixed to a shaft 24 to be described below is inserted, is formed at the first cam 10 in a radial direction of the first cam 10.

Furthermore, the second cam 12 has a substantially cylindrical shape, and has a recessed cam engaging portion 12b in which the cam portion 10b is dropped is formed on an end face of the second cam 12 facing the first cam 10. Since the opening and closing of the first and second members 6 and 8 are performed at a rotation angle of about 180°, the cam portion 10b and the cam engaging portion 12b are set according to the rotation angle so as to form an engaged state where the cam portion and the cam engaging portion are engaged with each other at every rotation of about 180°, and a partially engaged state where a cam face of the projecting cam portion 10b partially comes in contact with the a cam face of the recessed cam engaging portion 12b. Meanwhile, substantially rectangular protrusions 12a, which are engaged with notch grooves formed on the outer periphery of a case (to be described below) so as to stop rotation, protrude from the outer periphery of the second cam 12.

In addition, the second cam 12 has a continuous groove 12c on the end face thereof opposite to the end face on which the cam engaging portion 12b is formed. The continuous groove 12c is formed in a rotation direction of the second cam 12, and includes a plurality of curved portions 12d and 12e having large and small radii of curvature as shown in FIG. 6. In this embodiment, the depth of the continuous groove 12c may be the same depth, but the depth of the groove may be changed. The continuous groove 12c of this embodiment may have a substantially astral shape as seen from the front. The continuous groove 12c includes curved portions 12e having a small radius of curvature that are provided at positions close to the outer periphery of the second cam 12, and curved portions 12d having a large radius of curvature that are provided at positions close to the inner periphery of the second cam 12. Meanwhile, reference numeral 12f denotes an insertion hole into which a shaft 24 to be described below is inserted.

Reference numeral 16 denotes balls that roll in the continuous groove 12c. The ball rolls or slides while about a half of the ball is fitted into the continuous groove 12c. Further, three or more balls 16 are disposed at appropriate intervals so that the second cam 12 or a ball holder 18 is easily balanced not to be inclined with respect to a central axis. Meanwhile, in this embodiment, four balls 16 are disposed at regular intervals.

Reference numeral 18 denotes a ball holder that has a substantially cylindrical shape. The ball holder 18 has an insertion hole 18a into which a shaft 24 to be described below is inserted. A flat portion of the insertion hole 18a comes in contact with an integral engaging portion 24c (to be described below) of the shaft 24, so that the ball holder 18 and the shaft 24 are rotated together with each other. Further, holding grooves 18c are formed in a radial direction on an end face 18b of the ball holder 18 that faces the second cam 12. A half of the ball 16 is fitted into the holding groove 18c, so that the holding groove 18c maintains the ball while allowing the ball to be movable. Four balls 16 are provided in this embodiment, and four holding grooves 18c are formed in a cross shape as shown in FIG. 7 in order to position respective balls.

Reference numeral 20 denotes an elastic member that is formed of a coil spring or the like. The elastic member 20 presses the ball holder 18 toward the second cam 12 by the elasticity thereof.

Reference numeral 22 denotes a case that has a substantially cylindrical shape. A large opening 22a is formed at one end of the case 22, and an insertion hole 22b into which a shaft to be described below is inserted is formed at the center of an end face of the other end thereof. Further, notch grooves 22c, into which the protrusions 12a of the second cam 12 are slidably fitted in an axial direction, are formed at the side surfaces of the case 22 from the opening 22a to the vicinity of the middle of the case 22.

Reference numeral 24 denotes a shaft, which passes through the first cam 10, the second cam 12, the ball holder 18, the elastic member 20, the case 22, and a washer 26. The shaft 24 includes a head portion 24a that has a diameter larger than the diameter of the insertion hole 22b of the case 22, and a shaft body 24b that is inserted into the insertion hole 22b. An integral engaging portion 24c, which has a substantially rectangular cross-section formed by chipping off the shaft in a vertical direction in FIG. 1, is formed at a tip portion of the shaft body 24b. Further, an insertion hole 24d into which an engaging pin 14 is inserted is formed in the vicinity of the tip of the shaft.

The above-mentioned component parts are assembled as follows: first, the shaft 24 is inserted into the insertion hole 22b of the case 22 together with the washer 26. The elastic member 20, the ball holder 18, the balls 16, the second cam 12, and the first cam 10 are inserted into the case 22 in this order, and are mounted on the shaft 24. In this case, the hole, which is formed at the center of each of the ball holder 18 and the first cam 10, is formed in a substantially rectangular shape so as to be fitted to the integral engaging portion 24c of the shaft 24. Accordingly, the holes of the ball holder and the first cam are engaged with the shaft 24, so that the ball holder, the first cam, and the shaft are rotated together as a single body. Meanwhile, since the hole 12f formed at the center of the second cam 12 has a circular shape, the second cam is rotatably mounted on the shaft 24. The protrusions 12a of the second cam are engaged with the notch grooves 22c of the case 22, so that the second cam 12 is slidable in an axial direction and the second cam 12 and the case 22 are rotated together as a single body.

Further, the engaging pin 14 is inserted from the insertion hole 10c of the first cam 10 that is mounted on the shaft 24, and the engaging pin 14 is inserted into the insertion hole 24d of the shaft 24 that communicates with the insertion hole 10c. As a result, the first cam 10 is fixed to the shaft 24. When the first cam 10 is fixed to the tip of the shaft 24 as described above, the second cam 12, the balls 16, the ball holder 18, the elastic member 20, and the case 22 are interposed between the first cam 10 and the head portion 24a of the shaft 24, and the ball holder 18 is biased so as to be pushed against the second cam 12 by the elastic member 20. Therefore, the balls 16 are interposed between the ball holder 18 and the second cam 12.

The balls 16, which are interposed between the second cam 12 and the ball holder 18 as described above, are held by the holding grooves 18c of the ball holder 18 so as to be movable in the radial direction and movable in the rotation direction along the continuous groove 12c of the second cam 12. Further, when the cam portion 10b of the first cam 10 is engaged with the cam engaging portion 12b of the second cam 12, the balls 16 are positioned at the curved portions 12e of the continuous groove 12c that has a small radius of curvature. When the cam portion 10b is partially engaged with the cam engaging portion 12b, the balls are positioned at the curved portions 12d having a large radius of curvature.

The operation of the hinge device 2 having the above-mentioned structure will be described below. The hinge device 2 is mounted by inserting into the pivot sections 6a and 8a of the cellular phone 4 as shown in FIG. 4. The elastic engaging claws 10a are engaged with a receiving portion 6b of the pivot section 6a, so that the first cam 10 is fixed to the pivot section without separation and is rotated in accordance with the rotation of the pivot section 6a. Further, the case 22 is fixed into the pivot section 8a. Accordingly, the second cam 12 of which the protrusions 12a are fitted to the notch grooves 22c of the case 22 is rotated together with the case 22 in accordance with the rotation of the pivot section 8a. Meanwhile, the case 22 includes a pair of flat portions 22d. The flat portions 22d come in contact with flat portions 8b that are formed at the pivot section 8a, so that the case 22 is rotated in accordance with the rotation of the pivot section 8a.

When the first member 6 is rotated and opened from a closed state to a predetermined angle of about 180?, the first cam 10 is rotated together with the first member 6. When the first cam 10 and the second cam 12 of this embodiment are in a closed state where the first member 6 overlaps the second member 8 or an open state where the first member 6 is opened to a predetermined angle, the cam portion 10b and the cam engaging portion 12b are substantially in the engaged state. Accordingly, when the first member 6 is rotated to be opened, the first cam 10 is rotated and the engaged state between the cam portion 10b and the cam engaging portion 12b is released, so that the cam portion and the cam engaging portion are in the partially engaged state. In this case, the second cam 12 is pushed backward in the axial direction by the cam portion 10b of the first cam 10, and is pushed into the case 22 against the elasticity of the elastic member 20 while being guided by the notch grooves 22c of the case 22.

Further, in this case, the ball holder 18 is also rotated by the shaft 24 like the first cam 10. When the ball holder 18 is rotated as described above, the balls 16 held in the holding grooves 18c are also rotated together with the ball holder 18. In this case, the balls 16 are moved from the curved portions 12e of the continuous groove 12c of the second cam 12 toward the curved portions 12d.

When the balls 16 pass the curved portions 12d having a large radius of curvature as described above, the balls 16 are slightly moved in the holding grooves 18c in the radial direction. Accordingly, the rotation is not strongly suppressed, and the ball holder 18 and the first cam 10 are rotated while being slightly decelerated. As a result, the first member 6 is smoothly rotated and opened.

After that, when the first member 6 reaches a predetermined angle, the engaging state of the cam portion 10b of the first cam 10 and the cam engaging portion 12b of the second cam 12 is changed from the partially engaged state into the engaged state. In this case, the balls 16 reach the curved portions 12e of the continuous groove 12c. When the balls 16 reach or pass the curved portions 12e having a small radius of curvature as described above, the balls 16 are largely moved in the holding grooves 18c in the radial direction. For this reason, the rotation of the ball holler 18 is strongly suppressed, so that the ball holder 18 and the first cam 10 are braked. Accordingly, the first cam 10 is decelerated, the first member 6 is rotated while being decelerated before reaching a predetermined angle, and is stopped when being opened to a predetermined angle.

The operation of the hinge device 2 is the same as when the first member 6 is opened so that the state of the first member is changed from the open state into the closed state. Accordingly, the first member 6 is smoothly rotated first, and is decelerated and slowly closed before reaching a closed state.

Meanwhile, the ball holder 18 is biased toward the second cam 12 during the operation by the elastic member 20, so that the balls 16 are kept to be interposed between the ball holder 18 and the second cam 12. Further, the second cam 12 is pressed toward the first cam 10 with the balls 16 interposed therebetween by the ball holder 18, and is kept to come in contact with the first cam 10.

Further, the second cam 12 of this embodiment is rotated together with the case 22 and slides in the case 22 in the axial direction. However, if the case 22 is formed of a tubular body having a polygonal cross-section such as a hexagonal cross-section and the second cam 12 is formed of the same polygonal column, the second cam 12 may be mounted to be rotated together with the case 22 and may slide in the case 22 in the axial direction without providing the protrusions 12a and the notch grooves 22c.

Furthermore, in this embodiment, four balls 16 are disposed at regular intervals so that the second cam 12 pressed through the balls 16 is pressed to have a good balance with respect to the central axis. As long as the second cam 12 can be pressed to have a good balance as described above, the number of the balls 16 may be set to an arbitrary number that is equal to or larger than three. Meanwhile, in order to make a balance good, it is preferable that the holding grooves 18c be formed at regular intervals or symmetrically formed. Further, in order to suppress the rotation of the ball holder 18 and the first cam 10, at least one ball 16 may pass the curved portion 12e of the continuous groove 12c. Accordingly, the number of balls 16, which pass the curved portions 12e at the same time, may be arbitrarily set in accordance with the necessary braking force. Further, as long as the shaft 24 is engaged with the second cam 12 with high accuracy so that the second cam 12 is not inclined, the hinge device 2 is sufficiently operated even by one ball 16. Meanwhile, a ball has been used as a moving mediator in this embodiment, but a moving mediator is not limited to a ball. As long as a moving mediator makes the continuous groove and the holding grooves roll or slide therebetween and transmits driving torque, an oval body, a polygonal body, a polyhedral spherical body, a short cylindrical body, and other appropriate bodies may be used as the moving mediator.

Further, in this embodiment, the continuous groove 12c has been formed in a shape, which is symmetrical with respect to a diameter of the second cam 12, such as a substantially astral shape. However, the shape of the continuous groove does not need to be necessarily symmetric. For this reason, curved portions 12e having a small radius of curvature may be formed at a part of the continuous groove 12c so as to correspond to the engagement between the first cam 10 and the second cam 12 and to only the timing where the rotation is needed to be suppressed. Furthermore, an appropriate shape, which may perform the regulation of rotation, may also be employed as the shape of the holding grooves 18c of the ball holder 18 in relation to the shape of the continuous groove 12c.

The hinge device according to the invention and an apparatus using the hinge device are aimed at a cellular phone, a personal computer, and the like. However, if the regulation of opening/closing or rotation is required for objects, which are opened/closed or rotated, such as a makeup compact, a door, and a toilet lid, etc., the hinge device according to the invention and an apparatus using the hinge device may be applied to any object.

What is claimed is:

1. A hinge device for connecting a first member and a second member to be freely rotatable, comprising:
a first cam arranged to be rotatable together with the first member and including a cam portion formed of one of a recessed portion and a projecting portion;
a second cam arranged to be rotatable together with the second member for engaging the cam portion of the first cam, said second cam including a cam engaging portion formed of the other of the recessed portion and the projecting portion, said second cam further including a continuous groove having a plurality of curved portions and formed in a surface opposite to a surface of the second cam on which the cam engaging portion is formed in a rotation direction;
a transmission movable body arranged to be movable in the continuous groove;
a movable body holder arranged to be rotatable together with the first cam for positioning the transmission movable body so that the transmission movable body passes the curved portions of the continuous groove when the cam portion and the cam engaging portion become from a partially engaged state to an engaged state, said movable body holder including holding grooves in a surface of the movable body holder facing the continuous groove in a radial direction for holding the transmission movable body to be movable; and
an elastic member for pressing the movable body holder to bias the movable body holder toward the second cam,
wherein said transmission movable body passes the curved portions of the continuous groove to suppress a rotation when the first and second members rotate relative to each other and the cam portion and the cam engaging portion change from the partially engaged state to the engaged state.

2. The hinge device according to claim 1, wherein two or more transmission movable bodies are provided, said movable body holder positioning the transmission movable bodies so that at least one of the transmission movable bodies passes the curved portion of the continuous groove when the cam portion and the cam engaging portion change from the partially engaged state to the engaged state.

3. The hinge device according to claim 1, wherein said continuous groove includes a plurality of curved portions that have a plurality of radii of curvature.

4. The hinge device according to claim 3, wherein said curved portions includes curved portions having a large radius of curvature and curved portions having a small radius of curvature that are alternately disposed.

5. The hinge device according to claim 1, wherein said holding grooves are formed at regular intervals in a circumferential direction.

6. The hinge device according to claim 2, wherein said transmission movable bodies pass the curved portions of the continuous groove when the engaging state of the cam portion and the cam engaging portion is changed from the partially engaged state into the engaged state.

7. The hinge device according to claim 1, wherein the continuous groove has a depth changing, and said holding grooves have a depth corresponding to the depth of the continuous groove so that the transmission movable body is movably held by the holding grooves.

8. The hinge device according to claim 1, wherein said transmission movable body is a ball.

9. An apparatus comprising the hinge device according to claim 1 for pivotally connecting the first member and the second member.
